(19) United States
(12) Patent Application Publication
(10) Pub. No.: US 2006/0278068 A1
(43) Pub. Date: Dec. 14, 2006

(54) Guitar pedal

(76) Inventors: Soren Henningsen Nielsen, Lystrup (DK); Ivar Iversen, Arhus C (DK)

Correspondence Address: CANTOR COLBURN, LLP, 55 GRIFFIN ROAD SOUTH, BLOOMFIELD, CT, 06002, US

(21) Appl. No.: 11/439,915

(22) Filed: May 24, 2006

(30) Foreign Application Priority Data
May 24, 2005 (EP) EP 05011201.0

(51) Int. Cl. G10H 1/32; G10H 3/00

(52) U.S. Cl. 84/746

(57) ABSTRACT

The present invention relates to a sound controller system including at least one distance sensor provided to establish at least one distance representing signal, at least one mapper provided to map values of at least one of the distance representing signals into values of at least one control signal, the values of the control signal being within a predetermined interval, at least one interpreter provided to recognise occurrences of at least one predetermined distance variation pattern and on the basis thereof establishing at least one interpretation signal, and at least one sound controller provided to process at least one audio representing signal at least partly on the basis of at least one of the control signals and at least one of the interpretation signals. The present invention further relates to a method of controlling a sound controller.

### TECHNICAL FIELD OF THE INVENTION

The present invention relates to foot operated sound controllers, more particularly pedals for use with electric guitars, bass guitars, etc.

### BRIEF DESCRIPTION OF RELATED ART

It is known to convert the sound generated by a musical instrument into an electrical signal and to electronically process the signal in such electronic instruments as amplifiers, modulators, harmonizers, synthesizers and the like, in order to create a desired musical sound effect. For example, in the case of an electronic guitar, so-called “wah-wah” and “pitch bender” controllers are used to control the sound envelope.

Although generally satisfactory for their intended use, guitar controllers are typically operated by depressing foot pedals with one's foot, or by manipulating control buttons by hand. Such foot- or hand-operated controls are often not very convenient to operate and the possibilities for varying the physical requirements for engaging them are generally very limited. Furthermore, such controls generally depend on movable mechanical and/or electrical parts, which may operate in both dragging and uneven ways, produce audible and/or electrical noise, e.g. clicks or undesirable modulation effects, and which may deteriorate by time, thereby increasing the effect of, or introducing new, disadvantages.

It is also known in the musical field from U.S. Pat. No. 5,045,687 to translate body movements directly into musical tones. Typically, a light beam is produced in space and, thereupon, a portion of one's body, typically the hands, is positioned in the light beam in order to reflect light from the hands. This reflected light is detected and translated into an electrical signal, which, in turn, is processed into a musical tone. Such tone generators are highly satisfactory for their intended use, typically by dancers or like performance artists, but are not useful to performers whose hands are already occupied with playing a musical instrument.

Moreover, U.S. Pat. No. 5,475,214 discloses a system for modulating sounds from an instrument, for instance a guitar, by means of detecting movement of the modulating instrument and converting the detected signals into corresponding or correlated modulation of the sound. A problem related to such type of modulation is that it requires skills, which a musician, e.g. a guitarist, may find hard to acquire as relatively fixed instrument positions or movement patterns may often be regarded as restricting with respect to expression during performance.

### BRIEF SUMMARY OF THE INVENTION

The invention provides an input for a sound controller, preferably for use with guitars, which facilitates a high degree of adjustments related to the engagement of the controller, thereby, e.g., increasing the artist's freedom of performance while playing and/or facilitating different use of the controller for different events, environments, users, musical genres, etc.

The invention further provides a sound controller, preferably for use with guitars, which facilitates elimination of some of the problems associated with mechanical pedals, e.g. uneven motion, mechanical noise and/or deterioration.

The invention also provides a sound controller, preferably for use with guitars, which facilitates a high degree of freedom during performance or other use, as well as a high degree of user-adaptability.

The invention relates to a sound controller system comprising
at least one distance sensor 40, 52, 53 provided to establish at least one distance representing signal,
at least one mapper 47, 20, 21 provided to map values of at least one of said distance representing signals into values of at least one control signal 24, said values of said control signal being within a predetermined interval,
at least one interpreter 47, 20, 21 provided to recognise occurrences of at least one predetermined distance variation pattern and on the basis thereof establishing at least one interpretation signal, and
at least one sound controller 47, 20, 21 provided to process at least one audio representing signal 13 at least partly on the basis of at least one of said control signals 24 and at least one of said interpretation signals.

According to the present invention, a sensor capable of detecting distances or distance variations outputs a distance representing signal which is mapped into a control signal. The mapping enables a conversion from the sensor output value interval into a desired control value interval and, thus, facilitates conversion, scaling, mirroring, shifting, clipping, quantization, compression, non-linear mapping, table-based mapping, etc., of the sensor output values. The control signal established by the mapper is used as input to a sound processor for processing an audio channel. The audio processing is thus at least partly determined by the distance measured by the distance sensor, as the control signal is derived from the distance representing signal. The sound processor may be incorporated in a housing together with the sensor or, preferably, be a separate sound controller, preferably a commonly available sound controller. Any kind of sound processing is within the scope of the present invention, and may, e.g., comprise different kinds of modulation or distortion such as, e.g., wah-wah, chorus or reverb, alteration of audio attributes such as, e.g., volume, bass- or treble-contents, etc.

Moreover, an interpreter monitors distance variations by either monitoring the sensor output or the mapper output with the purpose of recognising predetermined variation patterns. The interpreter establishes an interpretation signal which, depending on the number of recognizable patterns and the use of the signal, may be a simple 1 bit digital or analogue signal, a continuous analogue signal or a several-bit digital signal. As distance variation patterns reflect movement patterns of, e.g., a foot in front of the sensor, the interpretation signal may be used for notifying other system components of the occurrence of special movement patterns. A preferred use of the interpretation signal is to notify the mapper or sound controller when the user removes the foot from the sensing direction or inserts the foot in the sensing direction of the sensor.

It is noted that the information from the interpreter may be utilised by the mapper as well as by the sound controller and that, in case of the former, the interpretation signal on which the processing is partly based may be represented by the control signal. In other words, the processing may apparently be based at least partly on the control signal alone if just the interpretation signal is processed and allowed to influence the control signal anywhere prior to the processing, e.g. by the mapper.

According to the present invention, an advantageous sound control system is obtained, particularly useful for artists playing guitars or guitar-like instruments such as basses, violins, etc. The system according to the present invention may also be useful for saxophonists, vocals, or other artists typically not able to control a sound controller by their hands during performance.

When said sound controller system comprises a foot-operated controller 10, wherein said distance representing signal represents the distance between at least a part of said foot-operated controller 10 and a foot of a user 11,

wherein said at least one mapper 47, 20, 21 establishes control signal 24 values within a predetermined interval,

wherein said interpreter 47, 20, 21 establishes hold-signals on the basis of predefined values, intervals or patterns of said control signal 24, said distance representing signal, or any combination thereof,

wherein said control signal 24, said distance representing signal, or any combination thereof, represents a predefined foot operation, and

wherein said audio representing signal 13 is derived from a guitar 12, an advantageous embodiment of the present invention is obtained.

According to the present invention, a guitar 12 is to be understood in a broad sense, and may thus be any hand-operated stringed instrument, acoustic, semi-acoustic or electric, such as, e.g., a guitar, a bass, an electric guitar, an electric bass, a ukulele, a banjo, a harp, a violin, etc. In order to establish the guitar audio representing signal 13 by use of the guitar 12 any suitable method may be used, e.g. by means of common pick-ups or instrument microphones.

When said sound controller system is distributed, an advantageous embodiment of the present invention is obtained.

According to an embodiment of the present invention, only the distance sensor, the mapper and the interpreter is located in the pedal housing. The control signal and possibly the interpretation signal is transmitted to a separate sound controller where the audio representing signal is processed according to the measurements of the distance sensor. The separate sound controller is possibly integrated with other sound controlling means, e.g. a mixer, amplifier, etc. It is noted that any distribution of the various parts of the system, including distribution of sub-parts, is within the scope of the present invention. An example of an embodiment with distributed sub-parts could be a system where mapping is performed partly in the pedal and partly in the sound controller, or the initial interpretation is performed in the pedal and further interpretation or decisions based on the interpretation, is performed in the sound controller.

When said sound controller system is integrated within one unit, such as a pedal 10, an advantageous embodiment of the present invention is obtained.

According to the present invention the full system may be integrated in one defined unit, e.g. a guitar foot pedal. Thereby, no common interfaces or particular functionality is required from the further sound processing devices, which may be part by the full setup. This may be particularly convenient for practicing or for the less equipped guitarist. Furthermore, merely replacing the relative cheap guitar foot pedal, instead of replacing probably much more expensive sound processing devices from the full setup, may give access to new functionality.

When at least one of said at least one distance sensor 40, 52, 53 is a non-contact sensor, an advantageous embodiment of the present invention is obtained.

By non-contact sensor is, according to the present invention, understood any device that is capable of establishing a representation of a distance or proximity to an object without requiring physical contact with that object. It is understood that, obviously, lack of physical contact does not exclude physical interaction, as any non-contact sensor in some way or the other interacts physically with the object, e.g. by reflection of sound or electromagnetic waves, e.g. light, by inductivity, etc. Hence, a non-contact sensor according to the present invention is any sensor that works without requiring the object to be monitored or sensed to actually touch the sensor, and thereby, the present invention allows the user to act and perform with a higher degree of freedom than typically experienced with, e.g., conventional guitar pedals.

When at least one of said at least one distance sensor 40, 52, 53 is adapted for operation by foot, an advantageous embodiment of the present invention is obtained.

When said audio representing signal is transmitted by means of at least one jack plug, an advantageous embodiment of the present invention is obtained.

When said control signal is transmitted by means of at least one jack plug, an advantageous embodiment of the present invention is obtained.

When the measuring range of at least one of said at least one distance sensor 40, 52, 53 comprises a mechanical end-point, an advantageous embodiment of the present invention is obtained.

According to a preferred embodiment of the present invention, a mechanical end-point, e.g. the upper surface of the pedal, is within the measuring range of the sensor(s). Thereby, the user is provided with one fixed point for orientation, compared to conventional guitar pedals having at least two fixed points.

When at least one of said at least one distance representing signal is an analogue signal and at least one of said at least one control signal 24 is a digital signal, an advantageous embodiment of the present invention is obtained.

According to a preferred embodiment of the present invention, the distance sensor is an analogue sensor providing an analogue distance representing signal, whereas the control signal is a digital signal, preferably for use with a digital sound controller.

When at least one of said at least one control signal 24 is derived from absolute values of at least one of said at least one distance representing signal, an advantageous embodiment of the present invention is obtained.

According to an embodiment of the present invention, the guitar pedal may operate in absolute mode, where same distances are preferably mapped to same control signal values. Thereby, the use of a pedal according to the invention may resemble the use of a conventional pedal fairly well, even though it may still provide features such as, e.g., much longer distance ranges than featured by conventional lever pedals.

When at least one of said at least one control signal 24 is derived from relative variations of at least one of said at least one distance representing signal, an advantageous embodiment of the present invention is obtained.

According to an embodiment of the present invention, the guitar pedal may operate in relative mode where same distance variations preferably are mapped to same control signal value variations, but not necessarily same distances to same values. Thereby, a pedal according to the present invention may feature much higher resolution within the convenient radius of action of a user's foot than a conventional lever pedal.

The present invention further relates to a method for controlling a sound controller, said method comprising the steps of
establishing at least one distance representing signal by means of at least one distance sensor 40, 52, 53,
mapping values of at least one of said distance representing signals into values of at least one control signal 24 by means of a mapper 47, 20, 21, said values of said control signal 24 being within a predetermined interval,
establishing at least one interpretation signal by recognising occurrences of at least one predetermined distance variation pattern by means of at least one interpreter 47, 20, 21, providing at least one of said at least one control signal 24 to said sound controller 47, 20, 21 at least partly as a basis for processing at least one audio representing signal 13.

According to the present invention, a sensor capable of detecting distances or distance variations outputs a distance representing signal which is mapped into a control signal. The mapping enables a conversion from the sensor output value interval into a desired control value interval and thus facilitates scaling, mirroring, shifting, clipping, quantization, compression, non-linear mapping, table-based mapping, etc., of the sensor output values. The control signal established by the mapper is used as input to a sound processor for processing an audio channel. The sound processor may be incorporated in a housing together with the sensor or, preferably, be a separate sound controller, preferably a commonly available sound controller. Any kind of sound processing is within the scope of the present invention, and may, e.g., comprise different kinds of modulation or distortion such as, e.g., wah-wah, chorus or reverb, alteration of audio attributes such as, e.g., volume, bass- or treble-contents, etc.

Moreover, an interpreter monitors distance variations by either monitoring the sensor output or the mapper output with the purpose of recognising predetermined variation patterns. The interpreter establishes an interpretation signal which, depending on the number of recognisable patterns and the use of the signal, may be a simple 1 bit digital or analogue signal, a continuous analogue signal or a several-bit digital signal. As distance variation patterns reflect movement patterns of, e.g., a foot in front of the sensor, the interpretation signal may be used for notifying other system components of the occurrence of special movement patterns. A preferred use of the interpretation signal is to notify the mapper or sound controller when the user removes the foot from the sensing direction or inserts the foot in the sensing direction of the sensor.

It is noted that the information from the interpreter may be utilised by the mapper as well as by the sound controller and that, in case of the former, the interpretation signal on which the processing is partly based may be represented by the control signal. In other words, the processing may apparently be based at least partly on the control signal alone if only the interpretation signal is processed and allowed to influence the control signal anywhere prior to the processing, e.g. by the mapper.

It is moreover noted that the individual steps of controlling a sound controller according to the present invention are not necessarily performed in the same sequence as mentioned above. The order of the steps of mapping and interpreting may, e.g., be determined by the actual application and especially in which parts of the application the functions are performed. If, e.g., a separate sound controller receiving a control signal from a pedal according to the present invention performs the interpretation, this is probably done subsequent to the mapping or simultaneously. If an advanced pedal performs both functions, the interpretation is probably performed prior to, or simultaneously with, the mapping. Thus, any order or simultaneousness of the steps is within the scope of the present invention.

When said method further comprises a step of providing at least one of said at least one interpretation signal to said sound controller 47, 20, 21 at least partly as a basis for said processing of said at least one audio representing signal 13, an advantageous embodiment of the present invention is obtained.

When said sound controller comprises a foot-operated controller 10,
said distance representing signal is established on the basis of the distance between at least a part of said foot-operated controller 10 and a foot of a user 11,
said values of at least one of said distance representing signals are mapped into values of said at least one control signal 24 within a predetermined interval,
said interpreter 47, 20, 21 establishes hold-signals on the basis of predefined values, intervals or patterns of said control signal 24, said distance representing signal, or any combination thereof,
said control signal 24, said distance representing signal, or any combination thereof, represents a predefined foot operation, and
said audio representing signal 13 is derived from a guitar 12, an advantageous embodiment of the present invention is obtained.

According to the present invention, a guitar 12 is to be understood in a broad sense, and may, thus, be any hand-operated stringed instrument, acoustic, semi-acoustic or electric, such as, e.g., a guitar, a bass, an electric guitar, an electric bass, a ukulele, a banjo, a harp, a violin, etc. In order to establish the guitar audio representing signal 13 by use of the guitar 12 any suitable method may be used, e.g. by means of common pick-ups or instrument microphones.

When said mapping of at least one of said at least one distance representing signal into values of at least one control signal 24 is controlled by at least one of said at least one interpretation signal, an advantageous embodiment of the present invention is obtained.

According to a preferred embodiment of the present invention, the control signal, which correlates to the sensor output, may also be altered by the interpretation signal, i.e. by occurrences of predetermined variation patterns of the sensor output. In a preferred embodiment of the present invention occurrences of such patterns may overrule the sensor output and, e.g., cause a hold of the control signal at one of its most recent values until, e.g., yet a predetermined variation pattern is recognised or the hold in some other way is removed. Thereby, a guitarist using a guitar pedal and sound control system incorporating an embodiment of the present invention may choose a certain control signal value by operating the non-contact sensor by his or her foot and then hold that value by performing a certain movement pattern, preferably as simple as possible, e.g. just removing the foot sideways from the sensing direction. While the control value is at hold, the guitarist is free to use his or her foot for other purposes until a new change of the control signal is desired. By performing a, preferably simple, movement pattern, e.g. just inserting the foot into the sensing direction of the sensor, the hold of the control signal may be removed and it may again follow changes of the sensor output. As a non-contact guitar pedal according to an embodiment of the present invention does not have a physical memory as constituted in conventional pedals by the distance between the ground and the pedal lever which does typically not change when the foot is removed, the sensor will recognise a removal of the foot as an infinite distance, and thereby output a signal being either the maximum or minimum value of the possible interval. By the present embodiment a method of avoiding the control signal to inevitably take a value of maximum or minimum when the foot is removed from the non-contact pedal is obtained and enables the guitarist to rest his or her foot or use it for controlling other control devices.

When at least one of said at least one control signal 24 and at least one of said at least one interpretation signal are arranged in a composite signal, an advantageous embodiment of the present invention is obtained.

The present invention further relates to a method of operating a guitar pedal system comprising a non-contact distance sensor, whereby predetermined movement patterns are assigned to predetermined control commands so as to enable a user to input said control commands to said guitar pedal system by performing said movement patterns.

According to the present invention, an advantageous method of controlling a guitar pedal, and thereby a sound controller or other sound processing means that the guitar pedal provides input for, is provided. In addition to allowing input of a value as conventional lever-operated guitar pedals do, the present invention further enables input of control commands without requiring the user to press additional buttons, turn a knob, etc. Such control commands may, e.g., comprise commands for “hold” the current value, “resume” reading new values, “mode” e.g. for changing between relative and absolute mode of operation, “control type” e.g. for changing between different types of sound control, etc.

According to the present invention, the non-contact distance sensor is used for several purposes, and thereby the user is provided with a guitar pedal which improves the freedom to act and perform while not limiting the powerful features provided by using a guitar pedal.

When said guitar pedal system comprises a sound controller system according to any the above claims, an advantageous embodiment of the present invention is obtained.

In a preferred embodiment of the present invention, a guitar pedal system according to the above description is arranged for operation according to the described method of operation.

When at least one of said predetermined control commands comprises a “hold” command, an advantageous embodiment of the present invention is obtained.

According to a preferred embodiment of the present invention, a “hold” command is arranged for, thereby enabling the user to leave the pedal while having it holding the last input value and using it as output value for the sound controller. The movement pattern associated with the “hold” command should preferably be a simple pattern, e.g. removing the foot sideways from the line of detection.

When at least one of said predetermined control commands comprises a “resume” command, an advantageous embodiment of the present invention is obtained.

According to a preferred embodiment of the present invention, a “resume” command is arranged for, thereby enabling the user to return to the pedal and having it resuming monitoring input values and outputting new values to the sound controller. The movement pattern associated with the “resume” command should preferably be a simple pattern, e.g. inserting the foot sideways into the line of detection.

When at least one of said predetermined control commands comprises a “mode change” command, an advantageous embodiment of the present invention is obtained.

According to an embodiment of the present invention, the user may change the pedal's mode of operation, e.g. between relative and absolute input modes, by performing a certain movement pattern.

When at least one of said predetermined movement patterns comprises removing the foot sideways from the line of detection of said distance sensor, an advantageous embodiment of the present invention is obtained.

When at least one of said predetermined movement patterns comprises inserting the foot sideways into the line of detection of said distance sensor, an advantageous embodiment of the present invention is obtained.

When said guitar pedal system comprises an interpreter for recognising said predetermined movement patterns from movements performed by a user, an advantageous embodiment of the present invention is obtained.

According to the present invention, an interpreter monitors distance variations by monitoring the distance sensor output or a representation thereof with the purpose of recognising predetermined variation patterns. The interpreter establishes an interpretation signal which, depending on the number of recognizable patterns and the use of the signal, may be a simple 1 bit digital or analogue signal, a continuous analogue signal or a several-bit digital signal. As distance variation patterns reflect movement patterns of, e.g., a foot in front of the sensor, the interpretation signal may be used for notifying other system components of the occurrence of special movement patterns. A preferred use of the interpretation signal is to notify the mapper or sound controller when the user removes the foot from the sensing direction or inserts the foot in the sensing direction of the sensor. The interpreter preferably outputs the predetermined control commands.

When said guitar pedal system establishes a level signal from movements not assigned to any control commands, an advantageous embodiment of the present invention is obtained.

According to a preferred embodiment of the present invention, the guitar pedal system is capable of providing a level signal resembling a conventional lever pedal, while still monitoring the signal to recognise predetermined movement patterns and if present, establish the associated control commands.

According to a preferred embodiment of the present invention, some control commands may influence the pedal level signal output, e.g. “hold” or “resume” commands, while other control commands may provide additional information to use with the level signal, e.g. change of sound modulation type, etc.

### BRIEF DESCRIPTION OF THE DRAWINGS

The invention will in the following be described with reference to the drawings where

FIG. 1 illustrates the use of an embodiment of the present invention in a simple guitarist's setup,

FIG. 2 illustrates the use of an embodiment of the present invention in a more complex setup,

FIG. 3 illustrates the use of an embodiment of the present invention in a further more complex setup,

FIG. 4 illustrates an embodiment of the present invention,

FIG. 5 illustrates a further embodiment of the present invention, and

FIG. 6 illustrates a further embodiment of the present invention.

### DETAILED DESCRIPTION OF THE INVENTION

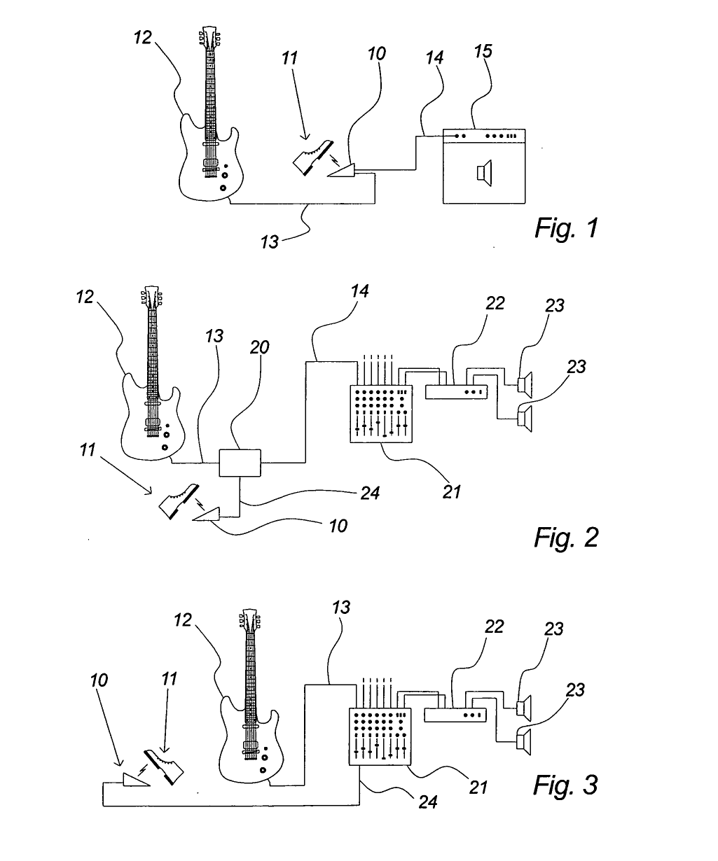

FIG. 1 illustrates an embodiment of the present invention in a simple setup. FIG. 1 comprises a guitar 12, a pedal 10 according to an embodiment of the present invention and a guitar amplifier with built-in speaker 15. An audio signal from the guitar 12 is transmitted to the pedal 10 by means of a first guitar audio representing signal 13. In the pedal the audio representing signal may be processed according to different parameters, at least one of which is controllable by foot 12. The processed guitar audio representing signal 14 is then transmitted to the guitar amplifier with built-in speaker 15, where it is amplified and rendered into a corresponding sound signal.

The guitar 12 is to be understood in a broad sense and may be any hand-operated stringed instrument, acoustic, semi-acoustic or electric, such as, e.g., a guitar, a bass, an electric guitar, an electric bass, a ukulele, a banjo, a harp, a violin, etc. In order to establish the guitar audio representing signal 13 by use of the guitar 12 any suitable method may be used, e.g. by means of common pick-ups or instrument microphones.

The guitar audio representing signal is usually an analogue signal transmitted by means of a shielded cable and ¼ inch jack plugs but may be any kind of signal transmitted by any suitable means, e.g., screened cables, coaxial cables, twisted pair cables, data cables, wireless transmission, etc., with any kind of plugs, e.g., ¼ inch, 3.5 mm or 2.5 mm jacks, XLR, BNC, phono, RJ-45, etc. The processed guitar audio representing signal 14 is preferably transmitted by similar means as the guitar audio representing signal 13 but may in a further embodiment be transmitted in a different way.

The guitar amplifier with built-in speaker 15 may be any suitable amplifier and speaker combination and may comprise further sound control or sound processing means, as may any part of the above-described system.

The pedal 10 may in the present embodiment be characterised as a foot operated sound controller. It may comprise processing means for performing, possibly simultaneously, one or several kinds of modulation or distortion such as, e.g., wah-wah, chorus or reverb, alteration of audio attributes such as, e.g., volume, bass- or treble-contents, etc. At least one control parameter of at least one of the possible kinds of processing should be user-controllable by moving the foot 11 in a certain way in front of the pedal 10. In a preferred embodiment the use of the pedal 10 resembles the use of a common guitar pedal in that the control parameter value is correlated with the distance between the pedal 10 and the foot 11. The pedal 10 of the present embodiment does, however, not comprise the lever of a common guitar pedal and, thus, comprises no movable parts and no rest for the foot, except, of course, when placed such that the user may rest his or her heel on the floor or the stage. Instead, the movement of the foot 11 is detected by means of a non-contact sensor.

FIG. 2 illustrates a further embodiment of the present invention in a more complex setup. It comprises a guitar 12 transmitting a guitar audio representing signal 13 to a sound controller 20. The processed guitar audio representing signal 14 is transmitted to a mixer 21. The output from the mixer is transmitted to a public address PA setup, e.g. comprising an amplifier 22 and speakers 23.

The sound controller 20 may be any kind of means suitable for processing audio signals and it may comprise processing means for performing, possibly simultaneously, one or several kinds of modulation or distortion such as, e.g., wah-wah, chorus or reverb, alteration of audio attributes such as, e.g., volume, bass- or treble-contents, etc. At least one of the control parameters of the sound controller 20 should be user-controllable by means of a separate input device 10. In the embodiment of FIG. 2 such an input device is shown as a non-contact pedal 10 according to an embodiment of the present invention. The output of the pedal 10 is transmitted to the sound controller 20 by means of a control signal 24. In a preferred embodiment the use of the pedal 10 resemble the use of a common guitar pedal in that the control signal value is correlated with the distance between the pedal 10 and the foot 11. The pedal 10 of the present embodiment does, however, not comprise the lever of a common guitar pedal and, thus, comprises no movable parts and no rest for the foot, except, of course, when placed such that the user may rest his or her heel on the floor or stage. Instead the movement of the foot 11 is detected by means of a non-contact sensor.

The control signal 24 may be any of the kinds of signals and transmitted by any of the means suitable therefore described in connection with the audio representing signals 13 and 14 above. The control signal 24 does, however, not have to be the same kind of signal as the audio signals 13 and 14 or use the same transmission means. It is preferably a digital signal transmitted by means of a twisted pair data cable and RJ-45 plugs but may as well be any kind of analogue or digital signal, e.g. a MIDI signal transmitted via DIN-plugs or a serial data signal transmitted via a USB interface and cabling.

Notes regarding the kind of guitar 12 and signals 13 and 14 and means for their transmittal are mentioned above with regard to the embodiment of FIG. 1.

The mixer 21 may be any kind of mixer comprising any kind and number of input and output channels and any kind of sound control possibilities, both per channel, per output and for the main control of the mixer. The PA setup may be any suitable kind of setup, e.g. an amplifier 22 and two speakers 23 as shown in FIG. 2. In further embodiments the output of the sound controller 20 or the mixer 21 may be transmitted to other targets such as, e.g., a suitable recorder, a further processing installation, etc.

FIG. 3 illustrates a further embodiment of the present invention. It corresponds to the embodiment of FIG. 2 except that the sound controller in the embodiment of FIG. 3 is shown as an integral part of the mixer 21 which, thus, receives the guitar audio representing signal 13 directly form the guitar and the control signal 24 directly from the pedal 10 according to an embodiment of the present invention.

As with the above embodiments any further sound processing may be performed in any part of the setup.

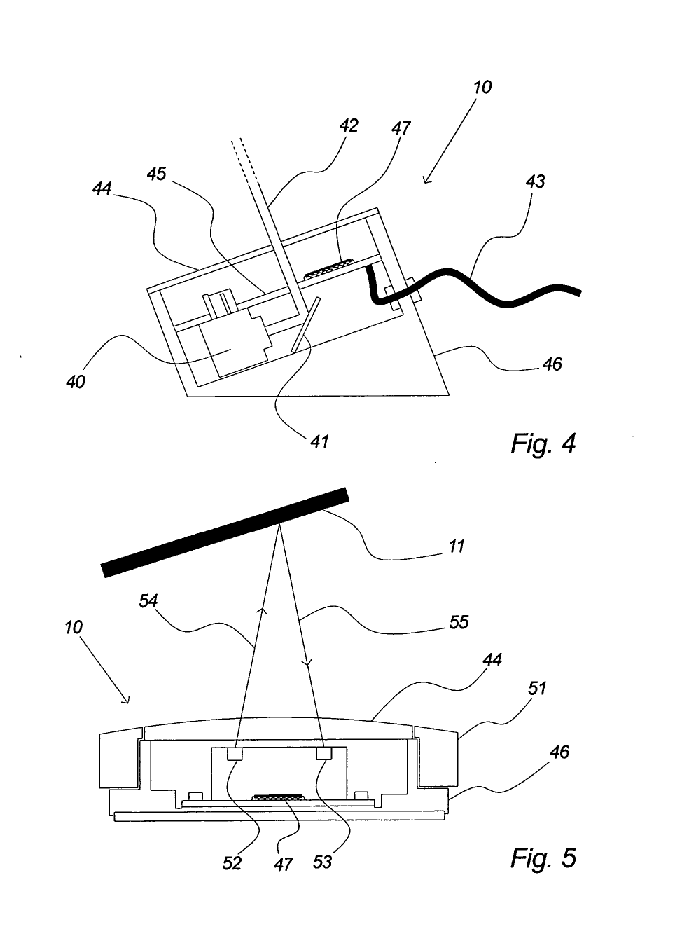

FIG. 4 illustrates an embodiment of a guitar pedal 10 according to the present invention. It comprises a base 46, a cover 44, a printed circuit board PCB 45, a processing means 47, an infrared light transceiver 40, a mirror 41 and a wire 43.

It is initially noted that whereas the present embodiment is shown using an infrared transceiver for distance measurement, any suitable technology and any method of exploiting such is within the scope of the invention. Suitable technologies may, e.g., comprise measurement of the amount, angle, and/or modulation of reflected infrared light, ultrasound, visible light, microwaves, other kinds of electromagnetic waves or sound, etc. Further suitable technologies exploit digital cameras, CCD-arrays, or any other technology suitable for non-contact distance or proximity sensing. Furthermore, the pedal may comprise several sensors of same or different type and technology in order to increase the precision, the usable space above the pedal, or in order to enable sensing in more dimensions, e.g. 2 or even 3 dimensions. More detailed description of how the measurement is performed will not be given here, as the skilled person will appreciate that several possible methods and technologies are suitable for this purpose and these have already been extensively described in the literature. Several chips and electronic devices enabled to do such measurements without further development are generally available on the market. Any of such devices, as well as chips specifically developed for this purpose, is within the scope of the present invention.

The infrared transceiver 40 emits an infrared light beam 42 which is directed away from the pedal 10 by means of a mirror 41. In an alternative embodiment the infrared transceiver 40 is rotated in order to emit the light beam directly away form the pedal. In further embodiments the transceiver and mirror is positioned otherwise, or alternative mirroring devices are used, e.g. a total internal reflection TIR prism. Furthermore, different types of lenses, light modulating rods, etc., may be utilised in order to support a specific measurement technology, pedal design and environment.

The processing means 47 may be any kind of means suitable for supporting the distance sensor and for processing the output of the sensor. The processing means may comprise discrete analogue or digital components, logic gates, chips, microprocessors, digital signal processors, programmable gate arrays, or any other kind of electronics. The processing means may be distributed among several components or it may be embodied in a single device.

The extent of features built into the processing means 47 depends on the intended use of the pedal 10. In a simple guitarist's setup as, e.g., illustrated in FIG. 1 the pedal 10, and thereby the processing means 47, should be able to do everything from supporting the distance sensor, mapping the values into a desired control parameter interval, performing modulation of a guitar audio representing signal 13 at least on the basis of that control parameter, on the basis thereof establishing a processed guitar audio representing signal 14 suitable for transmission to subsequent processing, e.g. by a guitar amplifier with built-in speakers, and possibly also interpreting the measured distance signal in order to recognise specific variations indicating that the user inputs a command such as “hold” or “resume”. This last-mentioned feature will be described in more detail below.

In more complex setups as, e.g., illustrated in FIGS. 2 and 3, the pedal 10 and thereby the processing means 47 should only establish one or more control parameters for use as input in a separate sound controller 20 or mixer 21. The above-mentioned interpretation feature may be located in the pedal or in a subsequent device such as a sound controller 20 or mixer 21.

The wire 43 may, thus, for some embodiments be used for transmitting a processed guitar audio representing signal 14 and in other embodiments be used for transmitting a control signal 24. In further embodiments the pedal 10 may comprise several wires, e.g. in order to be able to receive a guitar audio representing signal 13 or transmitting an interpretation signal. The wire 43 or wires may comprise any of the technologies and physical embodiments of plugs etc. mentioned above regarding the different signals illustrated in FIG. 1 to 3, or any other suitable technologies and physical embodiments.

The embodiment of FIG. 4 comprises a PCB 45 to which the electronic devices may be fixed. It is noted that even though this may be the convenient and preferred solution, the present invention is in no way limited to necessarily comprise a PCB. Several common alternatives exist for the skilled person to utilise.

The base 46 may be any suitable housing for a pedal as described. It is preferably made of a suitable kind of impact strengthened plastic and preferably provided with a non-skid bottom. It is preferably fairly heavy, or provided with a fairly heavy element, in order to not skid around on the floor. It is noted, however, that any kind of housing is within the scope of the present invention.

The cover 44 may be any suitable means for protecting the electronics, mirror and other devices inside the pedal. It should, moreover, be transparent to the infrared light beam 42, or at least comprise an area transparent to the beam 42. It may preferably comprise visible indications such as, e.g., information about settings or measurements and graphical and written branding, etc. Further, it may preferably comprise input means other than the non-contact sensor(s) such as, e.g., touch sensitive surfaces, buttons, knobs, etc.

The base and/or the cover is preferably designed in such a way that the upper surface of the pedal has an angle compared to the floor which is greater than 0° and preferably less than 45°, e.g. 20°. Thereby, operation of the pedal by foot is facilitated as the user is able to place his or her foot directly on the cover, thus inputting the minimum distance or lever it to any distance within a range of physically possible or convenient distances while keeping his or her heel on the floor at all times, thereby decreasing fatigue and increasing precision. It is noted that any other design and any other mode of operation, e.g. a design which does not facilitate keeping the heel on the floor, is within the scope of the present invention.

FIG. 5 illustrates a further embodiment of a pedal 10 according to the present invention. It comprises a base 46, a cover 44, processing means 47, an infrared emitter 52, an infrared receiver 53 and possibly a parameter input ring 51.

All notes regarding possible embodiments of the different parts and possible further features mentioned above regarding FIG. 4 apply likewise to the embodiment of FIG. 5. The embodiment of FIG. 5 may correspond to the embodiment of FIG. 4 seen from another direction, or it may be an individual embodiment.

The infrared emitter 52 emits an infrared light beam 54 away from the pedal surface. The sole of a user's foot 11 possibly reflects the beam 54 and a reflected infrared light bead 55 is returned and received by the infrared receiver 53. By means of measuring the amount of reflected light or by means of trigonometry or any other suitable means, e.g. as described above regarding FIG. 4, a value representing the distance between the pedal 10 the foot 11 may be established. In a preferred embodiment the infrared emitter 52 comprises a single infrared light emitting diode, whereas the infrared receiver 53 comprises a linear CCD-array or another light detector comprising a plurality of detection points. By measuring the amount of light received in each detection point, it is possible to accurately determine the centre of the received light beam. By means of triangulation the distance to the reflecting surface can then be computed. Infrared distance measuring sensors based on this principle are commonly available, e.g. from Sharp.

In addition to or as an alternative to the possible input means located on the cover, the pedal may comprise a parameter input ring 51 for inputting a value by turning the ring. The ring may be used for inputting continuous or discrete values.

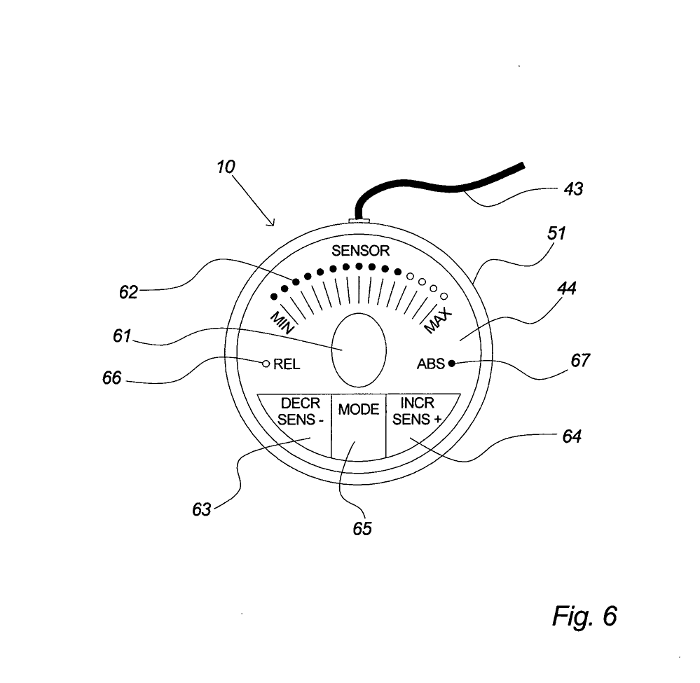

FIG. 6 illustrates a further embodiment of a pedal 10 according to the present invention. It shows an embodiment of the pedal from above and it may be one of the embodiments of FIG. 4 or 5 or a further embodiment. It comprises a cover 44, a wire 43, a parameter input ring 51, a sensor window 61, a sensor reading output 62, input means 63, 64, 65, and mode indicators 66, 67.

The cover 44 protects the internal parts of the pedal and constitutes a physical end stop for the distance measuring, but it may, furthermore, serve as a simple user interface for monitoring and operating the pedal. Such user interface elements may comprise outputs of different kinds such as, e.g., a sensor reading output 62 informing the user of the current reading. As the pedal comprises no physical lever, and thereby no means for aid to the user in remembering specific distance/value-combinations, such a sensor reading output 62 may be helpful. Mode indicators are also illustrated comprising an indicator for relative measurement mode 66 and absolute measurement mode 67. These modes will be described in more detail below.

Further, possible user interface elements comprise input means 63, 64, 65, which may, e.g. be used for increasing or decreasing the sensitivity of the sensor, increase or decrease the distance range operable, and/or change the current mode. The input means may, e.g., comprise touch sensitive surfaces, buttons or knobs, etc. It may, furthermore, comprise a parameter input ring 51 which may be used for inputting values by turning it clockwise or counter clockwise around the pedal circumference.

It is noted that application of any kind of user interface elements, branding, information, design, etc., to the pedal is within the scope of the present invention.

The sensor window 61 serves the purpose of allowing the infrared light beam or similar to be transmitted through the cover 44. The sensor window should thus be designed according to the distance measurement technology actually implemented. Hence, for infrared light technology, the sensor window may comprise a dark-red coloured cover almost opaque for visible light but transparent for infrared light, as known from other devices utilising infrared light such as remote controls, cell phones, etc. For other technologies the sensor window should be designed accordingly. The extend of the sensor window should also be designed with proper regard to the distance measuring technology applied and the desired specifications regarding detectable distance range, detectable spatial extend, etc. The sensor window 61 may comprise a lens or other optical means for focusing, filtering or otherwise alter the in- and/or out-going beams.

In a preferred embodiment of the present invention, an interpreter is comprised. The interpreter may be a separate component, or part of a processing means 47, a sound controller 20, a mixer 21, or any other means facilitating processing. The interpreter is preferably arranged to monitor the distance representing signal established by the infrared transceiver 40 or other equivalent component, the control signal established by the processing means 47, or any other signal derived from or on the basis of a user's interaction with the light beam 42 of the pedal.

The interpreter may recognise pre-defined or user-definable variations of the signal, and possibly establish an interpretation signal for, or control an input of, e.g., the processing means 47. Such recognisable variations may, e.g., comprise moving the foot relatively fast resulting in a fast variation of the distance representing signal, pressing the foot against the pedal surface resulting in the lowest possible value of the signal, or moving the foot sideways out of the beam resulting in the distance representing signal jumping from a certain value to infinite or maximum. Any other more or less complex movements and signal variations may be recognisable by the interpreter. The interpreter may comprise a pre-defined or user-definable tolerance level, incorporating timing and/or level tolerances.

The recognisable movement patterns or signal variations may be used as a further user interface. The movement patterns may, e.g., be assigned to different control functions, such as, e.g. “hold”, “resume”, “change mode”, “change sensitivity”, “change modulation type”, etc. The user may then be able to control a pedal according to the present invention by foot operations only, including parameter changes and hold/resume when, e.g., the user wants to move around on the stage.

In contrary to a common guitar foot pedal where the lever typically stays in the position in which it was last set, an embodiment of the present invention does not comprise a lever. As soon as the user moves the foot, the pedal basically interprets that as a lever repositioning. To avoid that the user has to keep his or her foot in the desired position at all times, the interpreter facilitates the input of, e.g., a “hold” command causing the modulation control signal to be held at the last level, even though the user moves or removes the foot. This facilitates, according to the present invention, a pedal to better resemble the functionality of a common foot pedal. A further movement pattern may be recognised as a “resume” command causing the modulation control signal to again follow the foot movements. A preferred movement pattern assigned to the “hold” command may comprise removing the foot sideways from the light beam. A preferred movement pattern assigned to the “resume” command may comprise repositioning the foot at the level corresponding to the currently held modulation control signal value. Several movement patterns may be assigned to one and the same command. In an embodiment of the invention, either removing the foot sideways or moving it fast compared to normal use may, e.g., apply the “hold” command. In a further embodiment of the invention, either repositioning the foot to the last used position, or positioning the foot directly on the pedal surface may, e.g., apply the “resume” command. In a further embodiment of the invention, e.g. tapping the pedal surface twice, may apply a further command, e.g. “change mode” or “change modulation type”.

In a preferred embodiment of the present invention a mapper is comprised. The mapper may be a separate component or part of a processing means 47, a sound controller 20, a mixer 21, or any other means facilitating processing. The mapper is preferably arranged to map measured distances or other output from the infrared transceiver or processing means into a control signal for controlling the modulation of sound. The infrared transceiver and/or processing means may establish a distance representing signal of a certain configuration having values within a certain interval. Such distance representing signal may, e.g., be a continuous analogue signal between 0V and 5V representing distance between 0 cm and 50 cm. The control signal for controlling the sound modulation in the processing means, the sound controller or the mixer, may, e.g., be required to be an 8 bit digital signal, thus capable of representing 256 levels. In such an embodiment the mapper may, e.g., perform mapping where a measured distance of 0 cm, e.g. corresponding to 0V, is mapped to the digital value 0 and a measured distance of 10 cm, e.g. corresponding to 1V, is mapped to the digital value 255. Thus, only a fifth of the usable distance interval is used but without decrease of resolution because of a 1-to-1 mapping of the intervals.

Any type and complexity of the mapping may be embodied by the mapper and is within the scope of the invention. Thus, mappings where the interval is reversed, mappings that linearize a non-linear interval or vice-versa, mappings converting between different signal representations, resolutions, etc., are within the scope of the invention. In a preferred embodiment of the present invention, the mechanical end-point of the interval, i.e. the physical surface of the pedal representing the physical minimum distance, is mapped to the maximum value of the control signal value interval, e.g. 255. Hence, the use of the pedal comprises one mechanical end-point, as compared to common guitar pedals comprising two mechanical end-points.

The modulation control value interval for a common guitar pedal is predetermined by the lever as the usable interval is limited by the minimum and maximum angles of the lever i.e. two mechanical end-points. The control value interval is, thus, derived from a few centimeters interval, e.g. 5 cm. As the distance-measuring device, e.g. an infrared transceiver, of an embodiment of the present invention is typically capable of measuring distances much greater, e.g., in the order of 50 cm. or a few meters, and as the usable interval is typically only limited in one end, i.e. only one mechanical end-point at the physical pedal housing, several further possible modes of operation may be implemented in embodiments of the present invention.

In an embodiment of the present invention the usable distance interval is limited in both ends by the physical pedal housing and a predetermined distance in a direction along the light beam of, e.g., 5 cm. Any distances outside this predetermined interval are mapped to the predetermined maximum or minimum values. Hence, an embodiment that very closely resembles a common guitar pedal is obtained even though one of the end-points is invisible and imperceptible. Such a mapping may be referred to as absolute mapping, as same distances are always mapped to same control signal values.

In a further embodiment of the present invention the usable distance interval is only limited in one end, i.e. the physical pedal housing. A measured distance according to the mechanical end-point is mapped to the maximum value of the control signal value interval, and a measured distance according to the greatest reckonable distance, e.g. 50 cm or 2 m, is mapped to the minimum value of the control signal value interval. Thereby, an absolute mapping is applied but facilitating a much greater precision than a common guitar pedal. The greater distances may, however, be more and more difficult to indicate by the user, especially when the embodiment is foot operated.

In a further embodiment of the present invention the same mapping embodiment as described above is implemented, i.e. having one mechanical end-point representing the maximum value of the control signal value interval. In the present embodiment the mapper, however, maps to a non-linear value range, e.g. similar to a decaying exponential function, a reciprocal function, etc. Hence, movements at relative great distances are mapped to relative small value changes in the control signal. The response is, thus, different at near and far distances, whereas the mapping is still absolute.

In an absolute mode mapping removing the foot from the light beam at one distance and inserting it into the beam at a different distance causes a change of control signal value. In an embodiment of the present invention relative mode mapping is provided by holding the active control signal value when the foot is removed from the light beam and not changing it when the foot is inserted at a different distance. Instead, the mapping is carried on from the active control signal value even though the distance is changed. Thus, the mapping is based on distance variations instead of the distances themselves.

In an absolute mode embodiment a change from, e.g., 70% to 60% of the distance interval would be mapped to, e.g., 70% and 60% of the control signal value interval, respectively. A removal of the foot, an insertion at 40%, and a movement to 30% would end up as a control signal value of 30% of the control signal value interval.

In a relative mode embodiment the same movements as described above would be interpreted as two times 10%-points movements, thus evaluating to a total of 20%-points movement. If the start value of the control signal were, e.g. 70%, the end value would be 50%, instead of 30% for absolute mode.

Relative mode, thus, facilitates a mapping where, e.g., only 10 cm range from the pedal surface is active but in the mapper constitutes only a few graduations, e.g. 1 cm corresponds to 1 out of 255. By moving the foot from the invisible maximum distance to the mechanical end-point the control signal value is only changed by 10 out of 255. But by removing the foot, lifting it, and moving it from the invisible maximum distance to the mechanical end-point once more, the control signal value is changed further by 10 out of 255, resulting in a total change of 20 out of 255. If the start value were 100, 10 full foot depressions would change that to 0.20 foot elevations within the beam would change the 0 to 200. Hence, the user may at a high resolution and very precisely manage the value of the control signal, but, however, only slowly manage large changes. The full 255-level interval is actually mapped from 255 cm, but only by using, e.g., 10 cm at a time, corresponding to what may be convenient by a foot operated device.

We claim:

1. Sound controller system, comprising:
at least one distance sensor provided to establish at least one distance representing signal,
at least one mapper provided to map values of at least one of said distance representing signals into values of at least one control signal, said values of said control signal being within a predetermined interval,
at least one interpreter provided to recognise occurrences of at least one predetermined distance variation pattern and on the basis thereof establishing at least one interpretation signal, and
at least one sound controller provided to process at least one audio representing signal at least partly on the basis of at least one of said control signals and at least one of said interpretation signals.

2. Sound controller system according to claim 1, wherein said sound controller system comprises a foot-operated controller,
wherein said distance representing signal represents a distance between at least a part of said foot-operated controller and a foot of a user,
wherein said at least one mapper establishes control signal values within a predetermined interval,
wherein said interpreter establishes hold-signals on the basis of predefined values, intervals or patterns of said control signal, said distance representing signal, or any combination thereof,
wherein said control signal, said distance representing signal, or any combination thereof, represents a predefined foot operation, and
wherein said audio representing signal is derived from a guitar.

3. Sound controller system according to claim 1, wherein said sound controller system is distributed.

4. Sound controller system according to claim 1, wherein said sound controller system is integrated within one unit.

5. Sound controller system according to claim 1, wherein at least one of said at least one distance sensor is a non-contact sensor.

6. Sound controller system according to claim 1, wherein at least one of said at least one distance sensor is adapted for operation by foot.

7. Sound controller system according to claim 1, wherein a measuring range of at least one of said at least one distance sensor comprises a mechanical end-point.

8. Sound controller system according to claim 1, wherein at least one of said at least one distance representing signal is an analogue signal and at least one of said at least one control signal is a digital signal.

9. Sound controller system according to claim 1, wherein at least one of said at least one control signal is derived from absolute values of at least one of said at least one distance representing signal.

10. Sound controller system according to claim 1, wherein at least one of said at least one control signal is derived from relative variations of at least one of said at least one distance representing signal.

11. Method for controlling a sound controller, said method comprising:
establishing at least one distance representing signal by means of at least one distance sensor;
mapping values of at least one of said distance representing signals into values of at least one control signal by means of a mapper, said values of said control signal being within a predetermined interval,
establishing at least one interpretation signal by recognising occurrences of at least one predetermined distance variation pattern by means of at least one interpreter,
providing at least one of said at least one control signal to said sound controller at least partly as a basis for processing at least one audio representing signal.

12. Method for controlling a sound controller according to claim 11, further comprising providing at least one of said at least one interpretation signal to said sound controller at least partly as a basis for said processing of said at least one audio representing signal.

13. Method for controlling a sound controller according to claim 11, whereby said sound controller comprises a foot-operated controller,
whereby said distance representing signal is established on the basis of a distance between at least a part of said foot-operated controller and a foot of a user,
whereby said values of at least one of said distance representing signals are mapped into values of said at least one control signal within a predetermined interval,
whereby said interpreter establishes hold-signals on the basis of predefined values, intervals or patterns of said control signal, said distance representing signal, or any combination thereof,
whereby said control signal, said distance representing signal, or any combination thereof, represents a predefined foot operation, and
whereby said audio representing signal is derived from a guitar.

14. Method for controlling a sound controller according to claim 11, whereby said mapping of at least one of said at least one distance representing signal into values of at least one control signal is controlled by at least one of said at least one interpretation signal.

15. Method for controlling a sound controller according to claim 11, whereby at least one of said at least one control signal and at least one of said at least one interpretation signal are arranged in a composite signal.

16. Method of operating a guitar pedal system comprising a non-contact distance sensor, the method comprising assigning predetermined movement patterns to predetermined control commands so as to enable a user to input said control commands to said guitar pedal system by performing said movement patterns.

17. Method of operating a guitar pedal system according to claim 16, whereby said guitar pedal system comprises a sound controller system comprising at least one distance sensor provided to establish at least one distance representing signal, at least one mapper provided to map values of at least one of said distance representing signals into values of at least one control signal, said values of said control signal being within a predetermined interval, at least one interpreter provided to recognise occurrences of at least one predetermined distance variation pattern and on the basis thereof establishing at least one interpretation signal, and at least one sound controller provided to process at least one audio representing signal at least partly on the basis of at least one of said control signals and at least one of said interpretation signals.

18. Method of operating a guitar pedal system according to claim 16, whereby at least one of said predetermined control commands comprises a “hold” command.

19. Method of operating a guitar pedal system according to claim 16, whereby at least one of said predetermined control commands comprises a “resume” command.

20. Method of operating a guitar pedal system according to claim 16, whereby at least one of said predetermined control commands comprises a “mode change” command.

21. Method of operating a guitar pedal system according to claim 16, whereby at least one of said predetermined movement patterns comprises removing a foot sideways from a line of detection of said distance sensor.

22. Method of operating a guitar pedal system according to claim 16, whereby at least one of said predetermined movement patterns comprises inserting a foot sideways into a line of detection of said distance sensor.

23. Method of operating a guitar pedal system according to claim 16, whereby said guitar pedal system comprises an interpreter for recognising said predetermined movement patterns from movements performed by a user.

24. Method of operating a guitar pedal system according to claim 16, whereby said guitar pedal system establishes a level signal from movements not assigned to any control commands.
